(19) United States
(12) Patent Application Publication
(10) Pub. No.: US 2008/0307197 A1
(43) Pub. Date: Dec. 11, 2008

(54) System and Method for Persistent Hardware System Serial Numbers

(76) Inventors: Duane A. Calvin, Austin, TX (US); John D. Upton, Georgetown, TX (US)

Correspondence Address: IBM Corporation (PEC);c/o Patrick E. Caldwell, Esq., The Caldwell Firm, LLC, PO Box 59655, DALLAS, TX, 75229-0655, US

(21) Appl. No.: 11/758,055

(22) Filed: Jun. 5, 2007

(51) Int. Cl. G06F 15/00

(52) U.S. Cl. 712/26; 712/E09.001

(57) ABSTRACT

A system for computer hardware serial number management includes a computer system chassis comprising a chassis serial number. The chassis serial number is embodied on the computer system chassis as a physical serial number. A first RFID tag is attached to the computer system chassis at a first location. The first RFID tag stores indicia of the physical serial number. A first electronic device couples to the computer system chassis, and comprises a first RFID reader configured to retrieve the stored indicia of the physical serial number from the first RFID tag and to determine the chassis serial number based on the retrieved indicia of the physical serial number.

### TECHNICAL FIELD

The present invention relates generally to the field of computer maintenance and tracking and, more particularly, to a system and method for providing persistent hardware system serial numbers.

### BACKGROUND OF THE INVENTION

Modern electronic computing systems, such as microprocessor systems, are often organized as diverse electronic components arranged inside a physical framework or enclosure. The electronic components can include circuit boards, disk drives, modem cards, sound/video cards, supplemental processing boards, network adapters, power supplies, and other suitable electronic components, as one skilled in the art will understand. The enclosure or “chassis” typically includes mounting brackets, slots, ports, cableways, and other mechanical devices for securing and interconnecting the electronic components. The chassis often includes a unique or semi-unique serial number, which is typically embodied as a physical serial number, sometimes represented as a bar code, which is printed on, or permanently etched into, the chassis itself. For ease of discussion and clarification, as used herein, a “physical serial number” is a serial number that is printed on, or permanently etched into, or otherwise attached to the chassis itself, and is a representation of the serial number assigned to the chassis.

Many modern businesses track their high-end computing equipment through the chassis physical serial number. That is, from the business accounting standpoint, the individual contents of the frame (i.e., the electronic devices coupled to the chassis) are relatively unimportant. Businesses operating under this model base all tracking, depreciation, and accounting for an asset on this mechanical metal frame and its physical serial number.

When operating under this business model, it is important to be able to read, electronically, the chassis serial number. Ordinarily, one or more cards within the chassis store a representation of the physical serial number in a special nonvolatile storage element. In most configurations, the one or more cards write to the special storage element during the manufacturing process when the card is first mated or coupled to a serialized chassis. When a card is first mated to a chassis, the card stores the correct chassis serial number, which matches the number printed on the chassis, that is, the physical serial number. In some cases, multiple electronic devices in the chassis include a special nonvolatile, write-once, storage element that indicates the chassis physical serial number. This redundancy helps ensure that the serial number will be available in the event of failure of one of the storage elements.

Typically, a card that contains the special storage element also performs other tasks and is occasionally replaced due to maintenance, upgrade, or repair. Thus, there is a significant problem associated with electronically storing a serial number on the internal components coupled inside the chassis. When the card that contains the special storage element is replaced with a new card, the new card's special storage element will not match the physical serial number of the chassis. The storage element of the replacement card may contain uninitialized or incorrect physical serial number information.

Where the representation of the physical serial number, stored in the special storage element, cannot be readily changed, the “old” chassis is deemed replaced by the “new” chassis represented by the serial number on the newly installed card, and not the actual, physical serial number imprinted on the chassis itself. In some cases, manufacturers must charge the price of a new chassis/enclosure since the serial number cannot be easily updated on the newly installed card assembly. In such cases, the chassis is considered to be exchanged in order to comply with the business accounting practices previously described.

In other cases, the serial number stored on the card can be changed. In such cases, however, this approach requires invoking secure methods to change the contents of the new card's special storage element. One known method to change the serial number is to provide a “secret menu,” whereby service personnel can rewrite the serial number storage element of the newly installed card to match the physical number of the chassis. This method incurs additional support and manpower costs and is prone to human error, for example, if the serial number is mistyped during the update.

Another method is to provide one or more duplicate storage elements on separate cards for the serial number, and (sometimes automatically) synchronize the storage elements (typically through a voting system) after a card replacement. This method avoids the added support and manpower costs of the secret-menu method, but runs into difficulties where multiple cards are replaced.

In another method, the chassis user orders replacement parts directly from the manufacturer, and the manufacturer preprograms the replacement parts with the correct chassis physical serial number. This method suffers from increased time delay costs and additional manpower costs. Again, with this method, there is increased error potential where the incorrect chassis physical serial number is inadvertently programmed into the replacement part storage element.

A related prior art method monitors the contents of an enclosure or chassis, through tracking or RFID tags affixed to each internal component. This approach is effective in identifying which internal components are inside a given chassis. But supplying RFID tags to each component only indicates which components (typically through a component serial number) are resident within a specified chassis. The physical serial number of the chassis remains unavailable to the internal components, and therefore does not solve the problem of providing the chassis serial number to the internal electronic devices. As described above, in some business accounting environments, only the chassis serial number is important.

Therefore, there is a need for a system and/or method for providing persistent hardware system serial numbers that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved hardware system serial number management method.

It is a further aspect of the present invention to provide for an improved hardware system serial number management system.

It is a further aspect of the present invention to provide for an improved asset tracking and management system.

The aforementioned aspects and other objectives and advantages can now be achieved as described herein. A system for computer hardware serial number management includes a computer system chassis comprising a chassis serial number. The chassis serial number is embodied on the computer system chassis as a physical serial number. A first RFID tag is attached to the computer system chassis at a first location. The first RFID tag stores indicia of the physical serial number. A first electronic device couples to the computer system chassis, and comprises a first RFID reader configured to retrieve the stored indicia of the physical serial number from the first RFID tag and to determine the chassis serial number based on the retrieved indicia of the physical serial number.

In an alternate embodiment, a method for computer hardware system serial number management includes attaching a first RFID tag to the physical computer system chassis in a first location. The first RFID tag stores indicia of a physical serial number and the physical serial number embodies a chassis serial number. A first electronic device coupled to the computer system chassis and comprising a first RFID reader retrieves the stored indicia of the physical serial number from the first RFID tag. The first electronic device determines the chassis serial number based on the retrieved indicia of the physical serial number.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an exemplary persistent hardware serial number management system in accordance with a preferred embodiment; and

FIG. 2 illustrates a block diagram showing a second exemplary persistent hardware serial number management system in accordance with a preferred embodiment; and

FIGS. 3a and 3b illustrate a high-level flow diagram depicting logical operational steps of a persistent hardware system serial number management method, which can be implemented in accordance with a preferred embodiment;

FIG. 4 illustrates a block diagram showing an exemplary model of the stored indicia representing a physical chassis serial number in accordance with a preferred embodiment; and

FIG. 5 illustrates a block diagram showing an exemplary table storing indicia representing a physical chassis serial number in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

The invention can take the form of an entirely hardware embodiment, an entirely software embodiment or an embodiment containing both hardware and software elements. In a preferred embodiment, elements of the invention are implemented in software, which includes but is not limited to firmware, resident software, microcode, etc.

Furthermore, elements of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, RFID readers, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

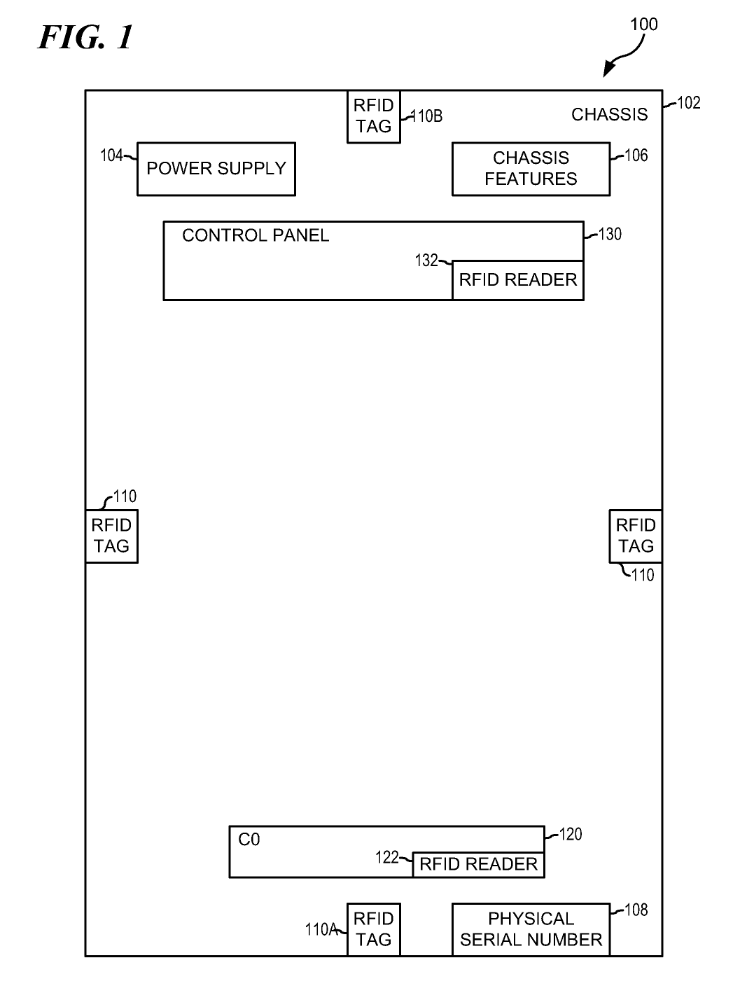

Referring now to the drawings, FIG. 1 is a high-level block diagram illustrating certain components of a system 100 for persistent hardware serial number management, in accordance with a preferred embodiment of the present invention. System 100 comprises a physical computer system chassis 102.

Chassis 102 is an otherwise conventional physical computer system chassis, modified as described below. For example, chassis 102 can comprise one or more racks, slots, cableways, ports, and/or other suitable mounting or connectivity features. These features are represented generally as chassis features 106. One skilled in the art will recognize a number of suitable chassis features.

As is typical for a physical computer system chassis, chassis 102 includes a chassis serial number (not shown), which is embodied as a physical serial number 108. Physical serial number (PSN) 108 is a physical embodiment of the serial number assigned to chassis 102. As such, in one embodiment, PSN 108 is a bar code affixed to a frame (not shown) of chassis 102. In an alternate embodiment, PSN 108 comprises an engraved serial number. One skilled in the art will recognize other suitable embodiments for PSN 108.

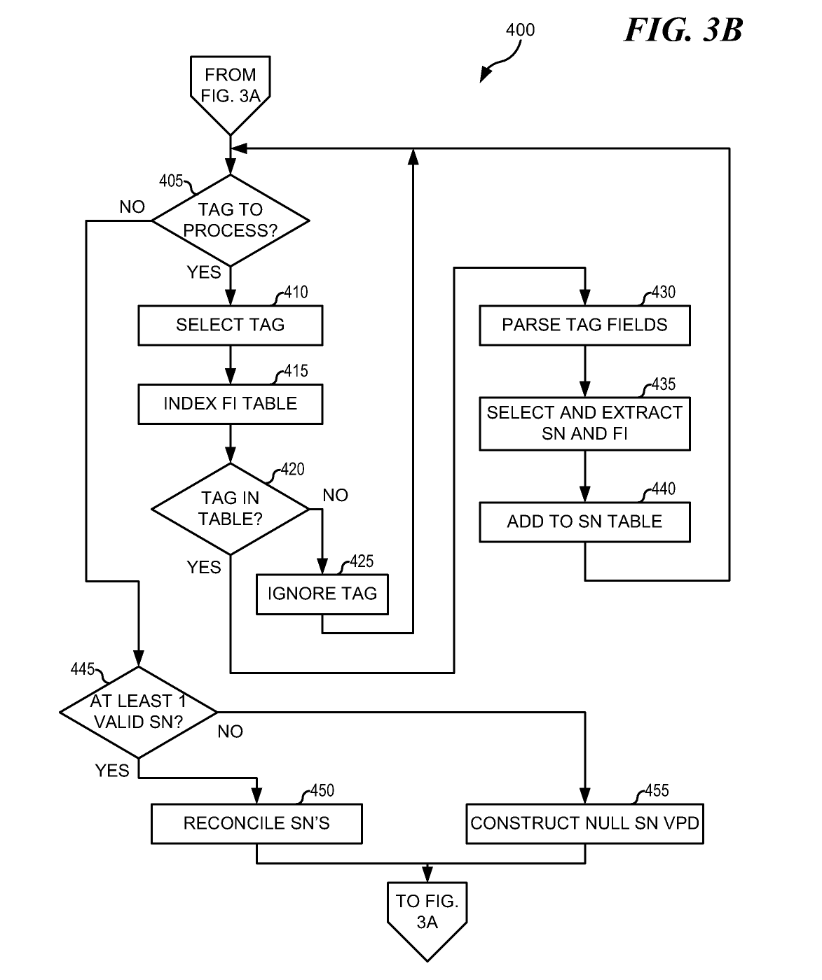

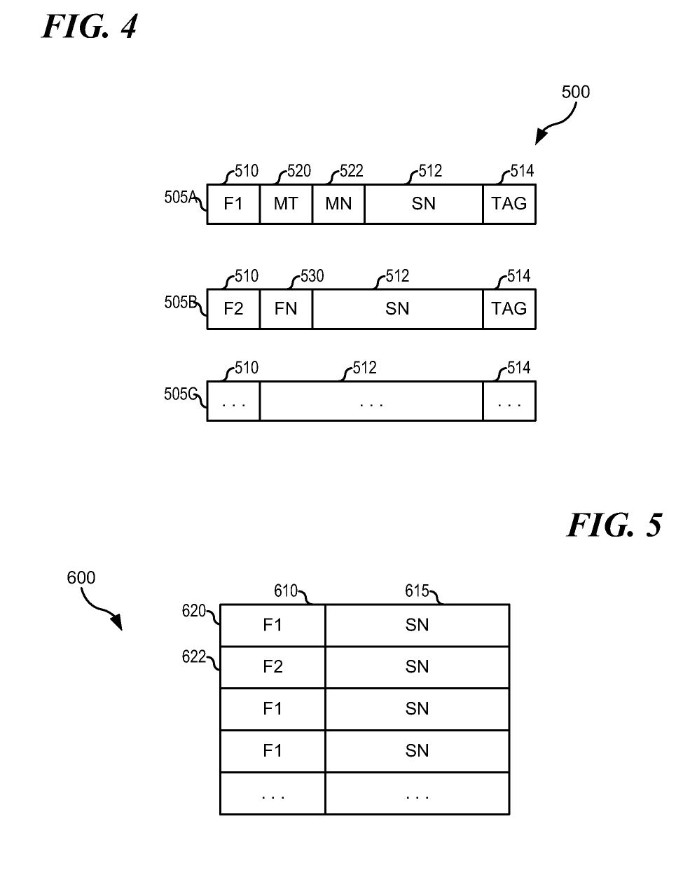

In the illustrated embodiment, chassis 102 also includes one or more chassis RFID tags 110. Chassis RFID tags 110 are otherwise conventional RFID tags, as one skilled in the art will understand. Each chassis RFID tag 110 includes indicia of the PSN 108. For example, in one embodiment, each chassis RFID tag 110 includes an interrogation response that returns a code mapping to PSN 108. In an additional embodiment, RFID tag 110 includes additional mapping fields. FIGS. 4 and 5, described in more detail below, illustrate block diagrams showing exemplary models of the stored indicia representing a physical chassis serial number, in accordance with preferred embodiments.

In the illustrated embodiment, chassis 102 includes four tags 110, coupled to chassis 102 at regular intervals. The illustrated configuration is by no means limiting, and instead represents one possible arrangement of the chassis RFID tags 110. Generally, in a preferred embodiment, the chassis RFID tags 110 are coupled to chassis 102 such that there is at least one chassis RFID tag 110 within observable RF range of every electronic device coupled to chassis 102, as described in more detail below. One skilled in the art will understand that the precise arrangement of chassis RFID tags 110 will depend on the number of available tags 110, the dimensions of chassis 102, and other suitable factors.

More particularly, one skilled in the art will understand that various electronic devices couple to chassis 102. For example, in the illustrated embodiment, a card CO 120 couples to chassis 102. Card CO 120 can be any number of suitable devices, and generally represents the typical devices that couple to a computer system chassis, such as, for example, disk drives and other storage media, and circuit boards, such as modem cards, sound/video cards, supplemental processing boards, network adapters, and other suitable electronic components, as one skilled in the art will understand. For ease of discussion, such devices are referred to as “a card” or “cards” herein.

Specifically, card CO 120 includes an RFID reader 122. RFID reader 122 is an otherwise conventional RFID reader. In operation, RFID reader 122 scans its observable RF field for RFID tags, interrogates any discovered tags, and receives interrogation responses from the discovered tags. In the illustrated embodiment, RFID reader 122 interrogates chassis RFID tag 110A, and receives indicia of PSN 108 from tag 110A. Depending on the signal strength of RFID reader 122, other tags 110 can also be within observable RF range of RFID reader 122, including, for example, chassis RFID tag 110B.

RFID reader 122 can be configured to scan periodically, or in response to a query from card CO 120, or be otherwise suitably configured. In a preferred embodiment, RFID reader 122 scans at least on card install, reset, and as requested by card CO 120. Having received the indicia of PSN 108 from a tag 110, RFID reader 122 can also be configured to determine the chassis serial number from the indicia of PSN 108 and to store the chassis serial number. In an alternate embodiment, RFID reader 122 passes the received indicia of PSN 108 to card CO 120, and card CO 120 subsequently determines the chassis serial number from the indicia of PSN 108 and stores the chassis serial number.

In an alternate embodiment, chassis 102 includes control panel 130. Generally, control panel 130 serves as a central repository for on-board coupled electronic devices to determine the chassis serial number for the chassis in which the cards are coupled. Specifically, in the illustrated embodiment, control panel 130 includes RFID reader 132. RFID reader 132 scans its observable RF field for RFID tags, interrogates any discovered tags, and receives interrogation responses from the discovered tags. In the illustrated embodiment, RFID reader 132 interrogates chassis RFID tag 110B, and receives indicia of PSN 108 from tag 110B. Depending on the signal strength of RFID reader 132, other tags 110 can also be within observable RF range of RFID reader 132, including, for example, chassis RFID tag 110A.

Having received the indicia of PSN 108 from a tag 110, RFID reader 132 can also be configured to determine the chassis serial number from the indicia of PSN 108 and to store the chassis serial number. In an alternate embodiment, RFID reader 132 passes the received indicia of PSN 108 to control panel 130, and control panel 130 subsequently determines the chassis serial number from the indicia of PSN 108 and stores the chassis serial number. In either case, when new cards are coupled to chassis 102, the newly coupled cards can request the chassis serial number from control panel 130. Control panel 130 returns the chassis serial number to the newly installed cards, which can process the returned serial number according to card requirements.

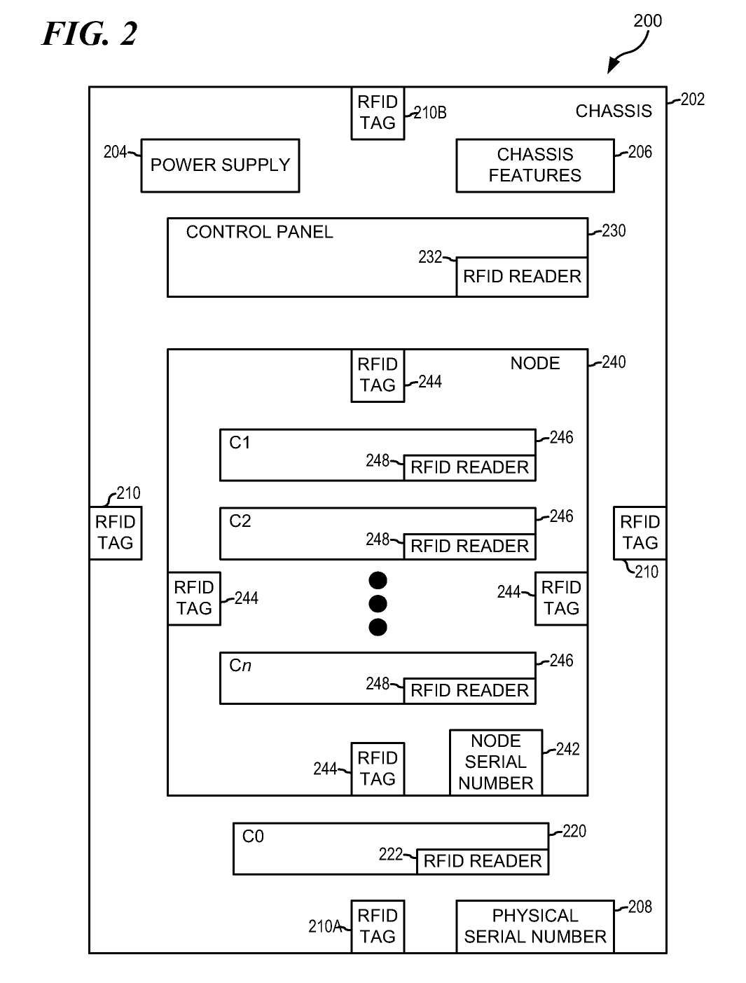

A hierarchical embodiment of the present invention is next described. Referring to the drawings, FIG. 2 is a high-level block diagram illustrating certain components of system 200 for persistent hardware serial number management, in accordance with a preferred embodiment of the present invention. System 200 comprises a physical computer system chassis 202. Components comprising the power supply 204, chassis features 206, card CO 220, RFID Tags 210, control panel 230, and physical serial number 208, are as previously described with respect to FIG. 1, above.

In some embodiments, chassis 202 includes one or more sub-chassis units or “nodes.” In the illustrated embodiment, chassis 202 includes node 240. Node 240 includes node physical serial number (NSN) 242. As is typical for a node in a physical computer system chassis, node 240 includes a node serial number (not shown), which is embodied as NSN 242. NSN 242, like PSN 208, is a physical embodiment of the serial number assigned to node 240. As such, one skilled in the art will recognize other suitable embodiments for NSN 242.

Node 240 includes one or more node RFID tags 244. Node RFID tags 244 are otherwise conventional RFID tags, as one skilled in the art will understand. Each node RFID tag 244 includes indicia of the NSN 242. For example, in one embodiment, each node RFID tag 244 includes an interrogation response that returns a code mapping to NSN 242. In an additional embodiment, RFID tag 244 includes additional mapping fields.

In the illustrated embodiment of FIG. 2, node 240 includes four tags 244, coupled within node 240 at regular intervals. The illustrated configuration is by no means limiting, and instead represents one possible arrangement of the node RFID tags 244. Generally, in a preferred embodiment, the node RFID tags 244 are coupled to node 240 such that there is at least one node RFID tag 244 within observable RF range of every electronic device coupled to node 240. One skilled in the art will understand that the precise arrangement of node RFID tags 244 will depend on the number of available tags 244, the dimensions of node 240, and other suitable factors.

Various electronic devices couple to node 244. For example, in the illustrated embodiment, a cards C1 to Cn 246 couple to node 240. Each card 246 can be any number of suitable devices, and generally represents the typical devices that couple to a node within a computer system chassis, such as, for example disk drives and other storage media, circuit boards, such as modem cards, sound/video cards, supplemental processing boards, network adapters, and other suitable electronic components, as one skilled in the art will understand.

Specifically, each card 246 includes an RFID reader 248. In an alternate embodiment, one or more cards 246 do not include an RFID reader 248. RFID reader 248 is an otherwise conventional RFID reader. In operation, RFID reader 248 scans its observable RF field for RFID tags, interrogates any discovered tags, and receives interrogation responses from the discovered tags. Additionally, depending on the signal strength of RFID readers 248, one or more chassis RFID tags 210 can also be within observable RF range of RFID reader 248, including, for example, chassis RFID tags 210A and/or 210B.

Chassis 202, tags 210, tags 244, and/or RFID reader 248 can be configured in a variety of modes where there are one or more chassis RFID tags 210 also within the observable RF range of RFID reader 248. For example, in one embodiment, node RFID tags 244 employ a distinct interrogation response that indicates a node physical serial number, as opposed to a chassis physical serial number. In an alternate embodiment, chassis RFID tags 210 employ a distinct interrogation response that indicates a chassis physical serial number, as opposed to a node physical serial number. In an alternate embodiment, RFID reader 248 conducts polling operations to determine whether its associated card 246 is located within a node 240, or the chassis 202 generally. In a preferred embodiment, RFID reader 248 is configured to read, and distinguish between, both node RFID tags 244 and chassis RFID tags 210. One skilled in the art will recognize other suitable configurations.

Like RFID reader 122 in FIG. 1 or RFID reader 222, RFID reader 248 can also be configured to scan periodically, or in response to a query from its associated card 246, or be otherwise suitably configured. In a preferred embodiment, RFID reader 248 scans at least on card install, reset, and as requested by its associated card 246. Having received the indicia of NSN 242 from a tag 244, RFID reader 248 can also be configured to determine the node serial number from the indicia of NSN 242 and to store the node serial number. In an alternate embodiment, RFID reader 248 passes the received indicia of NSN 242 to its associated card 246, and the card 246 subsequently determines the node serial number from the indicia of NSN 242 and stores the node serial number. In an alternate embodiment, each card 246 is also configured to determine the chassis serial number from the indicia of NSN 242 and to store the chassis serial number.

In an alternate embodiment, one or more cards 246 can function as a control panel for the node 240. For example, in one embodiment, card C1 246 serves as a control panel for node 240, and each other card C2 to Cn 246 are configured to request the node/chassis serial numbers from card C1 246. One skilled in the art will recognize other suitable configurations.

Thus, generally, system 200 includes a node 240, wherein a node physical serial number 242 is contained on node RFID tags 244 mounted inside the node cabinet 240 in RF observable locations relative to the cards 246. Cards 246 that are required to be traceable to a node serial number include an RFID reader 248 (and microcode for operating the RFID reader) to read the tags 244, and cache the result in local nonvolatile memory. In one embodiment, replaced cards 246 start life with a local memory storage that includes a null serial number field. At card power-on, the replaced card 246 receives indicia of the NSN 242 from the RFID tags 244 inside node 240, applies the appropriate selection mechanism, and selects a node serial number from among those indicated by the RF observable tags 244.

Subsequently, the replaced card 246 caches the node serial number, typically into a card identification VPD (Vital Product Data, typically stored in a non-volatile storage element on a card), thereby adopting the serial number of the node 240 to which the card is coupled. In one embodiment, replacement of a hardware subsystem piece that contains one or more of the RFID tags for the node/chassis serial number causes a null field in the local storage location that is identifiable as a replacement part. In an alternative embodiment, the local storage location instead contains a FRU (Field Replaceable Unit) reference number. Null or FRU reference number fields can then be ignored when deriving system serial number during programming of a new replacement part.

Likewise, chassis RFID tags 210 in multiple locations record the serial number of a system, that is, chassis 202, reflecting the serial number physically stamped on the frame, PSN 208. In one embodiment, the RFID tags 210 are readable by a control panel 230. In an alternate embodiment, one or more cards 220/246 read the chassis RFID tags 210, or other units that need to read it. In this manner, frame-wide or node-wide serial numbers can be tracked and electronic components contained within can be identified with the appropriate serial number.

That is, since one problem with known methods for tracking physical computer system serial numbers is that the actual chassis imprinted serial number cannot be read, the present invention makes the physical serial number readable by the internal electronics cards without actually storing a serial number permanently on the internal electronics cards. Instead, RFID tags that are physically part of the mechanical chassis assembly hold a representation of the chassis physical serial number. In one embodiment, chassis RFID tags 210 are written at the time of manufacture to match the chassis engraved or bar-coded serial number on the chassis (PSN 208). So configured, the electrical reading and reporting system/method for the chassis/node serial number is part of the internal electronics card, but the electronic serial number is physically part of the chassis 202.

So configured, system 200 provides numerous technical advantages not present in prior art systems and methods. One significant advantage of system 200 over the prior art is that the electronic cards (220/246) can be replaced at will, and will always report the correct chassis serial number since they are reading it off the physical chassis, in the form of chassis RFID tags 210. As such, even if all cards within chassis 202 are replaced at the same time, the new cards still report the correct chassis serial number. As illustrated, multiple RFID tags 210/244 can be arranged to provide redundancy in case of tag damage, failure, or replacement.

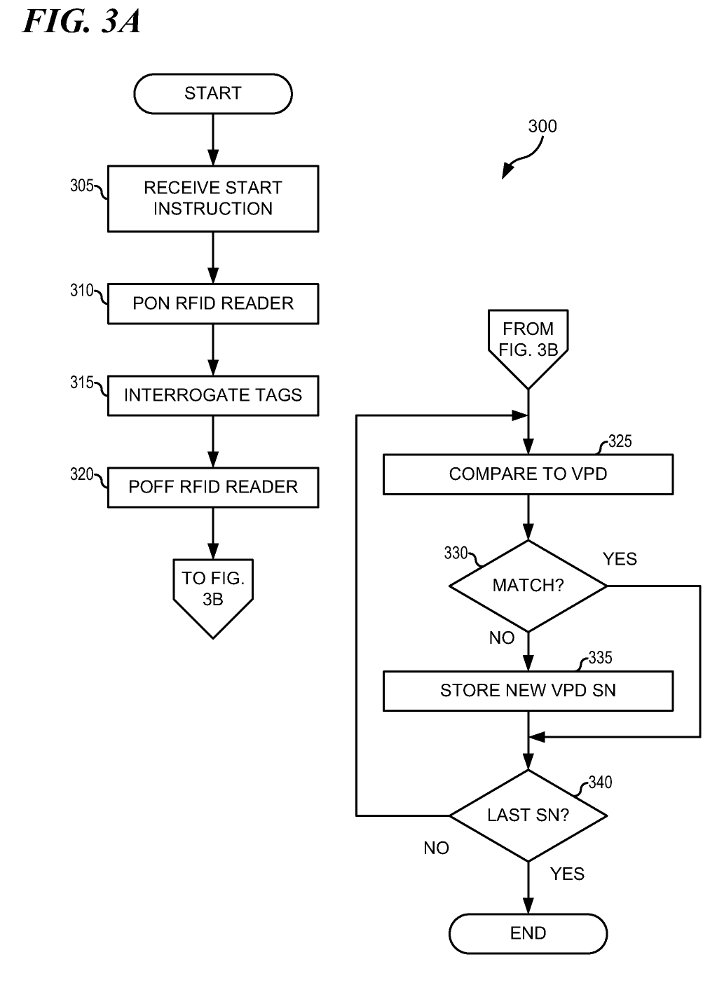

As described above, the present invention embodies a novel method for persistent hardware serial number management. FIGS. 3a and 3b illustrate another embodiment of a method for persistent hardware serial number management. Specifically, FIG. 3a illustrates a high-level flow chart 300 that depicts logical operational steps performed by, for example, system 200 of FIG. 2, which may be implemented in accordance with a preferred embodiment.

As indicated at block 305, the process begins, wherein the system or card receives a start instruction. The start instruction can be a system PON, system reset, or otherwise on request. Generally, the “start instruction” begins the sequence described below and can be an “identify instruction” a “reset instruction” or other suitable instruction, as one skilled in the art will understand.

Next, as illustrated at block 310, the system or card powers on the RFID reader. Next, as illustrated at block 315, the RFID reader interrogates the tags. Next, as illustrated at block 320, the system or card powers off the RFID reader. Next, the process continues as illustrated in FIG. 3b.

Referring now to FIG. 3b, illustrated is a high-level flow chart 400 that depicts logical operational steps performed by, for example, system 200 of FIG. 2, which may be implemented in accordance with a preferred embodiment. As illustrated at decisional block 405, a determination is made whether there are tags to be processed. If at decisional block 405 there are tags to process, the process herein continues along the YES branch to block 410.

As illustrated at block 410, the system or card selects a tag to process. Next, as illustrated at block 415, the system or card accesses a format indicator (FI) table index. Generally, the FI table contains an indexed list of known tags and predetermined tag information formats. Next, as illustrated at decisional block 420, the system or card determines whether there is an entry in the FI table corresponding to the selected tag.

If at decisional block 420, there is no entry in the FI table corresponding to the selected tag, the process continues along the NO branch to block 425. At block 425, the system or card ignores the tag and the process returns to block 405. If at decisional block 420, there is an entry in the FI table corresponding to the selected tag, the process continues along the YES branch to block 430.

Next, as illustrated at block 430, the system or card parses the tag fields. Next, as illustrated at block 435, the system or card selects and extracts the serial number (SN) and FI indicia from the parsed tag fields. Next, as illustrated at block 440, the system or card adds the extracted SN and FI indicia to an SN table, described in more detail below in conjunction with FIG. 5, and the process returns to block 405.

If at decisional block 405 there are no tags to process, the process continues along the NO branch to decisional block 445. As illustrated at block 445, the system or card determines whether there is at least one valid SN from among the extracted SNs (if any). If at decisional block 445 there is at least one valid SN from among the extracted SNs, the process continues along the YES branch to block 450. As illustrated at block 450, the system or card reconciles the extracted SNs with known SNs. The process returns to FIG. 3a.

If at decisional block 445 there is not at least one valid SN from among the extracted SNs, the process continues along the NO branch to block 455. As illustrated at block 455, the system or card constructs a null SN VPD (Vital Product Data). The process returns to FIG. 3a.

Referring now to FIG. 3a, the process continues to block 325. As illustrated at block 325, the system or card compares the returned SN of the FIG. 3b process with a current VPD (if any). Next, as illustrated at decisional block 330, the system or card determines whether the returned SN matches the current VPD (if any). If at decisional block 330, the returned SN does not match the current VPD, the process continues long the NO branch to block 335. As illustrated at block 335, the system or card stores the returned SN as the current VPD SN. The process continues to decisional block 340.

If at decisional block 330, the returned SN does match the current VPD, the process continues along the YES branch to decisional block 340. As illustrated at decisional block 340, the system or card determines whether the returned SN is the last SN. If at decisional block 340 the returned SN is not the last SN, the process continues along the NO branch, returning to block 325. If at decisional block 340 the returned SN is the last SN, the process continues along the YES branch, and the process ends.

The processes described above with respect to FIGS. 3a and 3b refer to both stored indicia representing a chassis/node PSN and a table of serial numbers. FIG. 4 illustrates a block diagram showing an exemplary model set 500 of the stored indicia representing a physical chassis or node serial number in accordance with a preferred embodiment. Model set 500 depicts three indicia configurations 505A, 505B, and 505C.

Generally, each configuration includes a format indicator (Fl) field 510, a serial number (SN) field 512, and a tag identifier field 514. As illustrated, configuration 505A, in format “F1”, also includes Machine Type (MT) field 520 and Model Number (MN) field 522. As illustrated, configuration 505B, in format “F2”, also includes a Feature Number (FN) field 530. Configuration 505C is a more abstract configuration including only fields 510, 512, and 514. One skilled in the art will understand that the systems described herein can also employ other suitable configurations.

As described above, FIG. 5 illustrates a block diagram showing an exemplary table 600 of the stored indicia representing a physical chassis serial number in accordance with a preferred embodiment. Generally, table 600 includes paired FI fields 610 and SN fields 615. In the illustrated embodiment, entry 620 is depicted in format “F1” and entry 622 is depicted in format “F2”. One skilled in the art will understand that the systems described herein can also employ other suitable configurations.

It will be appreciated that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A system for computer hardware serial number management, comprising:
a computer system chassis comprising a chassis serial number, the chassis serial number embodied on the computer system chassis as a physical serial number;
a first RFID tag attached to the computer system chassis at a first location, wherein the first RFID tag stores indicia of the physical serial number; and
a first electronic device coupled to the computer system chassis, and comprising a first RFID reader configured to retrieve the stored indicia of the physical serial number from the first RFID tag and to determine the chassis serial number based on the retrieved indicia of the physical serial number.

2. The system of claim 1, wherein the first electronic device further comprises a control module, the control module configured to:
store the chassis serial number; and
report the chassis serial number in response to a serial number query.

3. The system of claim 2, further comprising a second electronic device coupled to the computer system chassis and configured to transmit a serial number query to the control module, to receive the reported chassis serial number from the control module, and to store the reported chassis serial number.

4. The system of claim 1, further comprising a second RFID tag attached to the computer system chassis at a second location, wherein the second RFID tag stores indicia of the physical serial number.

5. The system of claim 4, wherein the first RFID reader is further configured to:
retrieve the stored indicia of the physical serial number from the first RFID tag and the second RFID tag; and
determine the chassis serial number based on the retrieved indicia of the physical serial number.

6. The system of claim 1, further comprising:
a node coupled to the computer system chassis and comprising a node serial number, the node serial number embodied on the node as a node physical serial number;
a second RFID tag attached to the node at a second location, wherein the second RFID tag stores indicia of the node physical serial number; and
the first RFID reader configured to retrieve the stored indicia of the node physical serial number from the second RFID tag and to determine the node serial number based on the retrieved indicia of the node physical serial number.

7. The system of claim 6, further comprising:
a second electronic device coupled to the node, and comprising a second RFID reader configured to retrieve the stored indicia of the node physical serial number from the second RFID tag and to determine the node serial number based on the retrieved indicia of the node physical serial number.

8. The system of claim 1, further comprising a plurality of RFID tags, each of the plurality of RFID tags configured to attach to the chassis and to store indicia of the physical serial number.

9. The system of claim 6, further comprising a plurality of RFID tags, each of the plurality of RFID tags configured to attach to the node and to store indicia of the node physical serial number.

10. A method for computer hardware system serial number management, comprising:
attaching a first RFID tag to the physical computer system chassis in a first location, wherein the first RFID tag stores indicia of a physical serial number, wherein the physical serial number embodies a chassis serial number;
retrieving the stored indicia of the physical serial number from the first RFID tag, by a first electronic device coupled to the computer system chassis, the first electronic device comprising a first RFID reader; and
determining the chassis serial number based on the retrieved indicia of the physical serial number.

11. The method of claim 10, further comprising:
storing the chassis serial number, by a control module of the first electronic device; and
in response to a serial number query, reporting, by the control module, the chassis serial number.

12. The method of claim 11, further comprising:
transmitting a serial number query to the control module, by a second electronic device coupled to the computer system chassis;
receiving the reported chassis serial number from the control module; and
storing the reported chassis serial number.

13. The method of claim 10, further comprising attaching a second RFID tag to the physical computer system chassis in a second location, wherein the second RFID tag stores indicia of the physical serial number.

14. The method of claim 13, further comprising:
retrieving, by the first RFID reader, the stored indicia of the physical serial number from the first or second RFID tag.

15. The method of claim 10, further comprising:
identifying a node coupled to the computer system chassis, the node comprising a node serial number;
attaching a second RFID tag to the node in a second location, wherein the second RFID tag stores indicia of a node physical serial number, wherein the node physical serial number embodies the node serial number;
retrieving the stored indicia of the node physical serial number from the second RFID tag, by the first RFID reader; and
determining the node serial number based on the retrieved indicia of the node physical serial number.

16. The method of claim 15, further comprising:
retrieving the stored indicia of the node physical serial number from the second RFID tag, by a second electronic device coupled to the computer system chassis, the second electronic device comprising a second RFID reader; and
determining, by the second electronic device, the node serial number based on the retrieved indicia of the node physical serial number.

17. The method of claim 10, further comprising attaching a plurality of RFID tags to the physical computer system chassis, each of the plurality of RFID tags configured to store indicia of the physical serial number.

18. The method of claim 15, further comprising attaching a plurality of RFID tags to the node, each of the plurality of RFID tags configured to store indicia of the node physical serial number.

19. A computer program product for computer hardware system serial number management, the computer program product having a tangible computer-readable medium with a computer program embodied thereon, the computer program comprising:
computer code for retrieving stored indicia of a physical serial number from a first RFID tag, wherein the physical serial number embodies a chassis serial number;
wherein the first RFID tag is attached to a physical computer system chassis in a first location, and the first RFID tag stores the indicia of the physical serial number; and
computer code for determining the chassis serial number based on the retrieved indicia of the physical serial number.

20. The computer program product of claim 19, further comprising:
computer code for retrieving stored indicia of a node physical serial number from a second RFID tag, wherein the node physical serial number embodies a node serial number;
wherein the second RFID tag is attached to a node of a physical computer system chassis in a second location, and the second RFID tag stores the indicia of the node physical serial number; and
computer code for determining the node serial number based on the retrieved indicia of the node physical serial number.
